(19) United States
(12) Patent Application Publication
(10) Pub. No.: US 2016/0026307 A1
(43) Pub. Date: Jan. 28, 2016

(54) SHADELESS TOUCH HAND-HELD ELECTRONIC DEVICE AND TOUCH-SENSING COVER THEREOF

(71) Applicants: HannStar Display (Nanjing) Corporation, Nanjing (CN); HANNSTAR DISPLAY CORPORATION, Taipei City (TW)

(72) Inventors: Hsu-Ho WU, Taipei City (TW); Tien-Rong LU, Taipei City (TW)

(21) Appl. No.: 14/725,043

(22) Filed: May 29, 2015

(30) Foreign Application Priority Data
Jul. 25, 2014 (CN) 201410361408.1

(51) Int. Cl. G06F 3/047; G06F 3/044; G09G 5/00

(52) U.S. Cl. CPC G06F 3/047; G09G 5/003; G06F 3/044; G09G 2330/022; G09G 2300/0426

(57) ABSTRACT

A shadeless touch hand-held electronic device includes a panel, a memory unit, a touch-sensing cover and a control unit. The touch-sensing cover has a cover and a touch-sensing structure. The cover is disposed on the side of the hand-held electronic device opposite the panel, partial or total area of the touch-sensing structure is disposed on the cover, and the touch-sensing structure has an activation area. The control unit is electrically connected to the touch-sensing structure and the memory unit. After the activation area being triggered, the shadeless touch hand-held electronic device is activated to an operative state.

### CROSS REFERENCE TO RELATED APPLICATIONS

This Non-provisional application claims priority under 35 U.S.C. §119(a) on Patent Application No(s). 201410361408.1 filed in People's Republic of China on Jul. 25, 2014, the entire contents of which are hereby incorporated by reference

### BACKGROUND

1. Technical Field

The invention relates to a hand-held electronic device, in particular to a shadeless touch hand-held electronic device and touch-sensing cover.

2. Related Art

With the progress of technologies, various novel information devices are invented, such as cell phones, tablet computers, ultrabooks, or GPS (Global Positioning System) navigation device, or other hand-held communication device, etc. In addition to conventional input or control manners by keyboard or mouse, utilizing the touch-control technique to operate the information device is a straight and popular operative manner. The touch display device has a friendly and intuitive input operation interface, and therefore users of all ages can manipulate the touch display device by fingers or a stylus.

As to the conventional hand-held electronic device with the touch function, the touch operations are all directly performed on the display panel. However, during operation on the panel, the user's finger may shade the user's view or the software item displayed on the display panel, such that the user may erroneously touch and open an undesired link in a high information content density on the display panel by the user's finger. Besides, the above-mentioned panel also needs to be configured with the transparent touch-sensing layer of the rare earth such as ITO (indium tin oxide) so as to be kept in high transparent display performance. However, the rare earth metal indium is unceasingly consumed, the cost of the product is getting higher and higher. Besides, the conductivity of the rare earth metal is worse than that of the normal metal. It seems not a good choice for adopting the rare earth to make the transparent touch-sensing layer. In addition, as the area of the display screen is enlarged, the area of the touch-sensing structure is also enlarged so as to increase the cost.

In addition, because users need to contact the touch panel with fingers or stylus to control or operate the electronic device, it often scratches the panel. Besides, when operating well-known hand-held electronic device with touch control function, it usually requires one hand to hold the hand-held electronic device and the other hand to operate on the panel. If using just one hand to hold and operate the device, only the user's thumb can manipulate the device, thus it is not convenient for users. Moreover, the touch range of the finger is increased with the increased size of the panel, and this will cause the corresponding increment of the area of the touch-sensing layer and the cost, and therefore the efficiency and convenience of the hand operation will be lowered down.

Furthermore, the sound button or power button is physically appears in most conventional hand-held electronic device. In addition to an extra manufacturing process to assemble, the mechanical structure also suffers from the duration problem and easily fails during operation as used for a long time. Thus, it reduces the duration of the hand-held electronic device, the appearance does not look streamlined and the anti-water design is obstructed due to the physical button.

Therefore, an aspect of this invention is to provide a shadeless touch hand-held electronic device and touch-sensing cover which can avoid the user's view from being shaded by the user's finger, and straightly and effectively detect the intention of turn-on/turn-off by the user without the physical power button.

### SUMMARY

An aspect of this invention is to provide a shadeless touch hand-held electronic device and touch-sensing cover which can avoid the user's view from being shaded by the user's finger without the physical power button.

A shadeless touch hand-held electronic device comprises a panel, a memory unit, a touch-sensing cover and a control unit. The touch-sensing cover has a cover and a touch-sensing structure. The cover is disposed on the side of the hand-held electronic device opposite the panel, partial or total area of the touch-sensing structure is disposed on the cover, and the touch-sensing structure has an activation area. The control unit is electrically connected to the touch-sensing structure and the memory unit. After the activation area being triggered, the shadeless touch hand-held electronic device is activated to an operative state.

In one embodiment, after the activation area being triggered, the shadeless touch hand-held electronic device is activated to the operative state from a sleep state, a standby state, a hibernate state, a hybrid sleep state or a shutdown state.

In one embodiment, the activation area acts for being triggered.

In one embodiment, when the shadeless touch hand-held electronic device is in a sleep state, a standby state, a hibernate state, a hybrid sleep state or a shutdown state, partial of the touch-sensing structure forms the activation area.

In one embodiment, the cover further includes a cover body and at least one sidewall, the sidewall extends from at least a part of the edge of the cover body, and the activation area is disposed on the cover body or the sidewall.

In one embodiment, the touch-sensing structure comprises metal mesh, metal nanowires, transparent conducting film, carbon nanotube or graphene.

In one embodiment, the touch-sensing structure is capacitive touch-sensing structure.

In one embodiment, the touch-sensing structure comprises a first sensing layer, a second sensing layer and a capacitance detection unit. The first sensing layer has a plurality of first sensing lines disposed along a first direction. The second sensing layer is disposed opposite the first sensing layer and has a plurality of second sensing lines disposed along a second direction. The first sensing lines and the second sensing lines cross each other to form a plurality of detection points. The capacitance detection unit is coupled with the touch-sensing structure to detect the variation of the coupling capacitance between the first sensing lines and the second sensing lines.

In one embodiment, the hand-held electronic device is operated by one hand.

In one embodiment, the shadeless touch hand-held electronic device has no physical power button.

In one embodiment, the memory unit stores an initiative determination condition, and the control unit on the activation area executes following steps of: computing a trigger event of the detection points; comparing the trigger event with the initiative determination condition pre-stored in the hand-held electronic device; and the activation area is triggered if the trigger event conforms to the initiative determination condition.

In one embodiment, a circuit board, a battery or a memory card is between the touch-sensing cover and the panel.

In one embodiment, the activation area is disposed on the lower part of the touch-sensing cover.

In one embodiment, a touch-sensing cover is disposed on a shadeless touch hand-held electronic device having a control unit. The touch-sensing cover comprises a cover and a touch-sensing structure. The touch-sensing structure is electrically connected to the control unit. Partial or total area of the touch-sensing structure is disposed on the cover, and the touch-sensing structure has an activation area. After the activation area being triggered, the shadeless touch hand-held electronic device is activated to an operative state.

In one embodiment, after the activation area being triggered, the shadeless touch hand-held electronic device is activated to the operative state from a sleep state, a standby state, a hibernate state, a hybrid sleep state or a shutdown state.

In one embodiment, the touch-sensing structure comprises a first sensing layer, a second sensing layer and a capacitance detection unit. The first sensing layer has a plurality of first sensing lines disposed along a first direction. The second sensing layer is disposed opposite the first sensing layer and has a plurality of second sensing lines disposed along a second direction. The first sensing lines and the second sensing lines cross each other to form a plurality of detection points. The capacitance detection unit is coupled with the touch-sensing structure to detect the variation of the coupling capacitance between the first sensing lines and the second sensing lines.

In one embodiment, the cover further comprises a cover body and at least one sidewall, the sidewall extends from at least a part of the edge of the cover body, and the activation area is disposed on the cover body or the sidewall.

In one embodiment, the touch-sensing structure comprises metal mesh, metal nanowires, transparent conducting film, carbon nanotube or graphene.

In one embodiment, the touch-sensing structure is capacitive touch-sensing structure.

In one embodiment, the activation area is operated by one hand.

In one embodiment, the activation area is disposed on the lower part of the touch-sensing cover.

In one embodiment, the control unit on the activation area executes following steps of: computing a trigger event of the detection points; comparing the trigger event with the initiative determination condition pre-stored in the hand-held electronic device; and the activation area is triggered if the trigger event conforms to the initiative determination condition.

As mentioned above, as to the shadeless touch hand-held electronic device and touch-sensing cover, the touch-sensing structure is disposed on the touch-sensing cover, the user can operate the hand-held electronic device by the touch-sensing cover. Thus, it avoids the user's view from being shaded by the user's finger during operation and the panel scratch can be reduced. Besides, if the touch-sensing structure is only disposed on the region operated by the finger, the area of the touch-sensing structure can be reduced and the cost is also reduced.

In one embodiment, a wiring connecting to the touch-sensing structure is gathered to a single side for wiring outlet.

In one embodiment, the width of the touch-sensing structure is less than that of the cover by 5%˜10%.

In one embodiment, the area of the touch-sensing structure and the area of the panel have a ratio relationship, and the control unit converts an input position of the touch-sensing structure into a display position of the panel.

In one embodiment, the hand-held electronic further comprises a near field communication unit. The near field communication unit has a near field communication chip and an antenna, the near field communication chip is electrically connected to the control unit, and the antenna is disposed on the cover or the touch-sensing structure.

In one embodiment, the touch-sensing structure is capable of a wireless power transmission.

As mentioned above, as to the shadeless touch hand-held electronic device and touch-sensing cover, the user can perform the touch operation on the touch-sensing cover of the hand-held electronic device, so the user's finger will not shade the view or the objects displayed on the panel, and the touch for opening the link of the high information density image will not erroneously execute. Besides, since operating the electronic device is performed on the touch-sensing cover, the panel scratch can be reduced. Furthermore, because the user can perform the touch operation on the touch-sensing cover, the user can use multiple fingers such as the forefinger and middle finger to operate the electronic device while using the same hand holding the device. In comparison with the conventional art where the user just can use the thumb to perform the operation while using the same hand holding the device, the disclosure can provide more manual efficiency and convenience and can realize a better user experience.

Furthermore, when the user uses the hand-held electronic device under the sun, he can hold the hand-held electronic device just by one hand and use the touch-sensing cover to block the sunlight or light source. Due to the panel information resulting from the touch-sensing cover which blocks the sunlight, the sunlight visibility of the panel is improved, and it can be implemented without advanced OLED or electric paper display panel technique.

Besides, the activation area which is located at the touch-sensing structure of the touch-sensing cover replaces the conventional physical button and this avoids the physical button from easily breaking Because the shadeless touch hand-held electronic device has no physical button, the design of the hand-held electronic device is more flexible and the appearance is more streamlined.

### BRIEF DESCRIPTION OF THE DRAWINGS

The embodiments will become more fully understood from the detailed description and accompanying drawings, which are given for illustration only, and thus are not limitative of the present invention, and wherein:

FIG. 1 is a schematic diagram showing the shadeless touch hand-held electronic device according to the embodiment of the invention;

FIG. 2 is a block diagram of the shadeless touch hand-held electronic device in FIG. 1;

FIG. 3 is a schematic diagram showing the activation area of the shadeless touch hand-held electronic device in FIG. 1;

FIG. 4 is a schematic diagram showing the activation area of the shadeless touch hand-held electronic device according to another embodiment; and

FIG. 5 is a schematic diagram showing the operation of the shadeless touch hand-held electronic device in FIG. 1.

### DETAILED DESCRIPTION OF THE INVENTION

The embodiments of the invention will be apparent from the following detailed description, which proceeds with reference to the accompanying drawings, wherein the same references relate to the same elements.

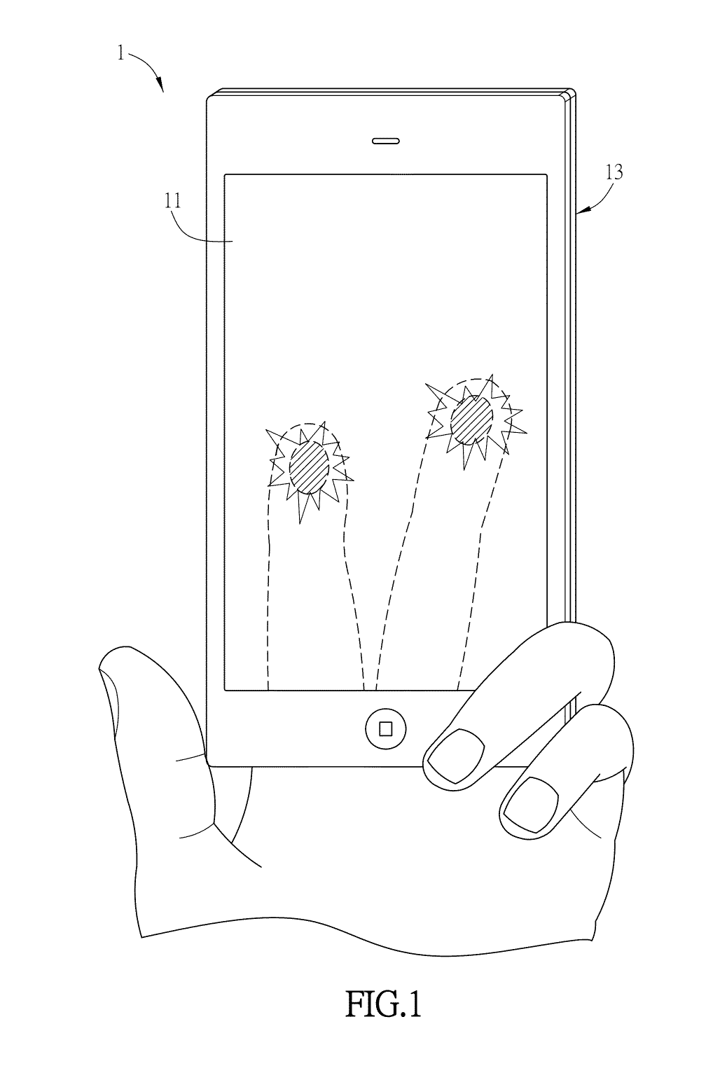

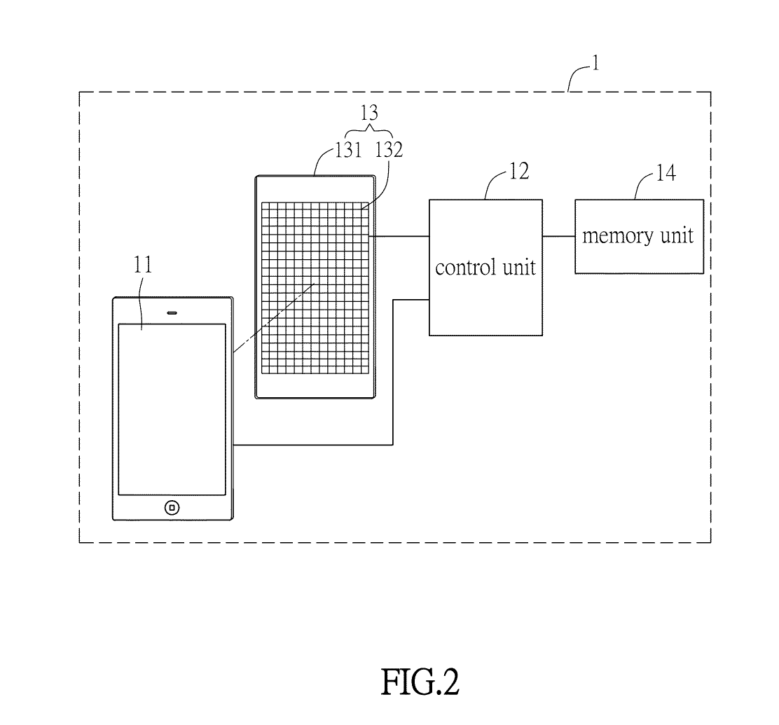

Referring to FIG. 1 to FIG. 2, FIG. 1 is a schematic diagram showing the shadeless touch hand-held electronic device according to the embodiment of the invention, and FIG. 2 is a block diagram of the shadeless touch hand-held electronic device in FIG. 1.

The shadeless touch hand-held electronic device 1 (hereinafter abbreviated to hand-held electronic device 1) for example can be a smart phone, a tablet computer, a PDA (personal digital assistant), a GPS (global positioning system) device, etc. Here, it is a smart mobile phone for example. Besides, the components of the hand-held electronic device 1 in the embodiment can be implemented or assembled with one or more than one hardware, software or firmware of the signal processing and/or integrated circuit or their any combination.

The hand-held electronic device 1 includes a panel 11, a control unit 12, a touch-sensing cover 13 and a memory unit 14. The control unit 12 is electrically connected to the panel 11, the touch-sensing cover 13 and memory unit 14.

The panel 11 is disposed on one side of the hand-held electronic device 1, for example a side of the hand-held electronic device 1 closer to the user's view. The panel 11 can be for example LCD (liquid crystal display) panel, OLED (organic light emitting diode) display panel, touch display panel, or electronic paper (electro-phoretic display panel), and it is not limited thereto. The panel 11 can display electronic data and for example provide GUI (graphical user interface). The GUI can have one or more graph so as to utilize graphs (for example icons) to show any kind of software part on the panel 11.

The control unit 12 is disposed on the circuit board which is disposed inside the hand-held electronic device 1, and it can be composed of one processor or multiple processors. The control unit 12 can control not only the content displayed on the panel 11 but also the operation or action of the touch-sensing cover 13. Besides, the memory unit 14 is a storing medium of the hand-held electronic device 1, and it can be the memory inside the hand-held electronic device 1 or outside the hand-held electronic device 1 (such as the cloud memory or cloud storage), but it is not limited thereto. The memory unit 14 can include, for example, ROM (Read-Only Memory), RAM (Random Access Memory), flash memory, FPGA (field-programmable gate array) or other kinds of memory, and it is not limited thereto. Besides, one or more programs can be stored in the memory unit 14 and it is adapted to be executed by the control unit 12 (may include one or more processors). Furthermore, the memory unit 14 also can store the operation system, application programs, data processing programs and electronic data of various documents, etc. The operation system is the program managing the computer hardware and software resources. The application program can be a document processing program or email program, etc. In the embodiment, the data processing programs are the programs which examine the data structure of the electronic data and generate corresponding connective instructions. In the embodiment, the control unit 12 includes a CPU (central processing unit) for example, and the control unit 12 executes these programs.

In the embodiment, the control unit 12 is disposed on the circuit board which is disposed inside the hand-held electronic device 1, and it can be composed of one processor or multiple processors. The control unit 12 can control not only the content displayed on the panel 11 but also the operation or action of the touch-sensing cover 13.

The touch-sensing cover 13 is disposed on the side of the hand-held electronic device 1 opposite the panel 11 (i.e. the opposite side to the display surface), for example the opposite side of the hand-held electronic device 1 is away from the user's view. The touch-sensing cover 13 includes a cover 131 and a touch-sensing structure 132. The touch-sensing structure 132 is electrically connected to the control unit 12.

The detail configuration and elements of the touch-sensing structure will be explained later, partial or total area of the touch-sensing structure 132 can be disposed on the cover 131. With difference from the conventional that the transparent touch-sensing structure of the panel must fully cover the overall panel, namely its area is substantially equal to the area of the panel, the touch-sensing structure 132 in the embodiment can only cover the region which the user's finger or palm would hold. Therefore, the user can directly operate by the same holding habit. An additional advantage of disposition only on the region operated by the finger is that the area of the touch-sensing structure 132 can be reduced so as to reduce the cost of the hand-held electronic device 1.

In other embodiments, the area of the touch-sensing structure 132 of the touch-sensing cover 13 can be smaller than the area of the panel 11. In other words, the area of the touch-sensing structure 132 and the area of the panel 11 have a ratio relationship to the area of the panel 11, and the ratio relationship is used for the control unit 12 to convert a touch point on the touch-sensing cover 13 into a display position of the panel 11.

When the user performs the touch operation on the touch-sensing cover 13 by finger for example, the panel 11 can display the corresponding operative instruction according to the user's operation gesture (or called the hand gesture), the control unit 12 will convert the input position of the touch-sensing structure 132 into the display position of the panel 11, and the panel 11 will display a visible sign on the display position so that the user can interact with the graphical user interface displayed on the panel 11.

Besides, other advantages of providing the touch-sensing cover 13 for the user's touch operation include that the touch-sensing cover 13 needn't be made by the transparent touch-sensing material (such as ITO) for matching the display performance of the panel 11, Naturally, the material selection will be more flexible and the cost can be easily controlled. Besides, no metal interference fringe will be caused to affect the readability of the display panel, the performance and convenience of the manual operation will not be lowered down.

The touch-sensing structure 132 can also yield to the position of the camera lens or the flash of the cover 131, so there is no touch-sensing structure 132 allocated at a local region of the cover 131 (namely the position of the camera lens or the flash).

Even if the size of the hand-held electronic device 1 is enlarged, it is not necessary to accordingly increase the area of the touch-sensing structure 132. Thus cost can be controlled.

The touch-sensing structure 132 can be for example capacitance touch-sensing structure, and it is disposed on the inner surface of the cover 131 facing the panel 11 (inside the hand-held electronic device 1), or disposed on the outer surface of the cover 131 away from the panel 11 (outside the hand-held electronic device 1), or simultaneously disposed on the inner surface of the cover 131 facing the panel 11 and the outer surface of the cover 131 away from the panel 11 (inside and outside the hand-held electronic device 1). The touch-sensing structure 132 in the embodiment can be directly formed on the cover body 1311 and two sidewalls 1312 for example. In other embodiments, when the touch-sensing structure 132 is disposed on the outer surface of the cover 131 away from the panel 11, an additional protection layer is required to protect the touch-sensing structure 132.

Moreover, it is noted that the cover 131 can be glass, plastic, metal or other material, and it can be a part of the total structure of the hand-held electronic device 1. In other words, the touch-sensing cover 13 is not an additional component (such as the protection case or protection sheath of the electronic device). Therefore, if the touch-sensing cover 13 is separated from the hand-held electronic device 1, the inside parts of the hand-held electronic device 1 for example battery or IC (integrated circuit), etc. can be seen. Regardless of not shown in figure, a circuit board, a battery or a memory card may be further included between the touch-sensing cover 13 and the panel 11.

In some embodiments, the hand-held electronic device 1 can further include another touch-sensing structure (not shown in the figure). Another touch-sensing structure can be disposed on the panel 11 so the panel 11 becomes a touch display panel. Therefore, in addition to performing shadeless touch operation on the cover 131 by the user, another touch-sensing structure also provides another operation interface for communicating with the device. Thus, the user can choose to perform shadeless touch operation on the cover 131, or alternatively operate the hand-held electronic device 1 directly on the touch display panel, or alternatively operate the hand-held electronic device 1 concurrently on the touch-sensing cover 131 and the touch display panel.

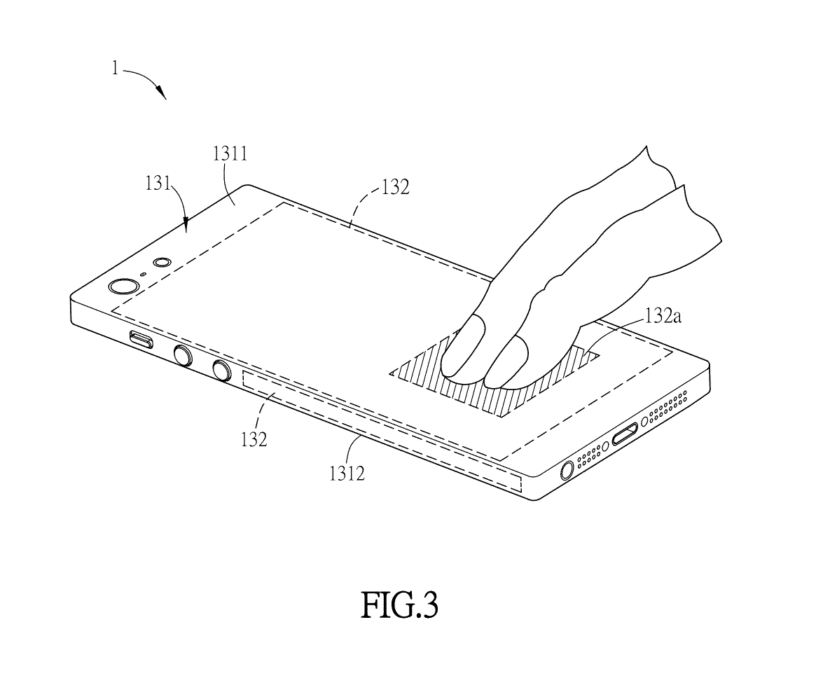

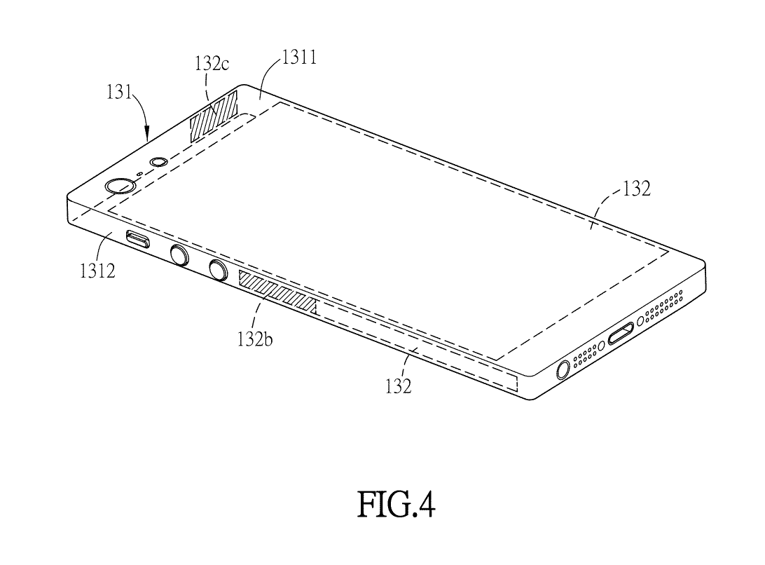

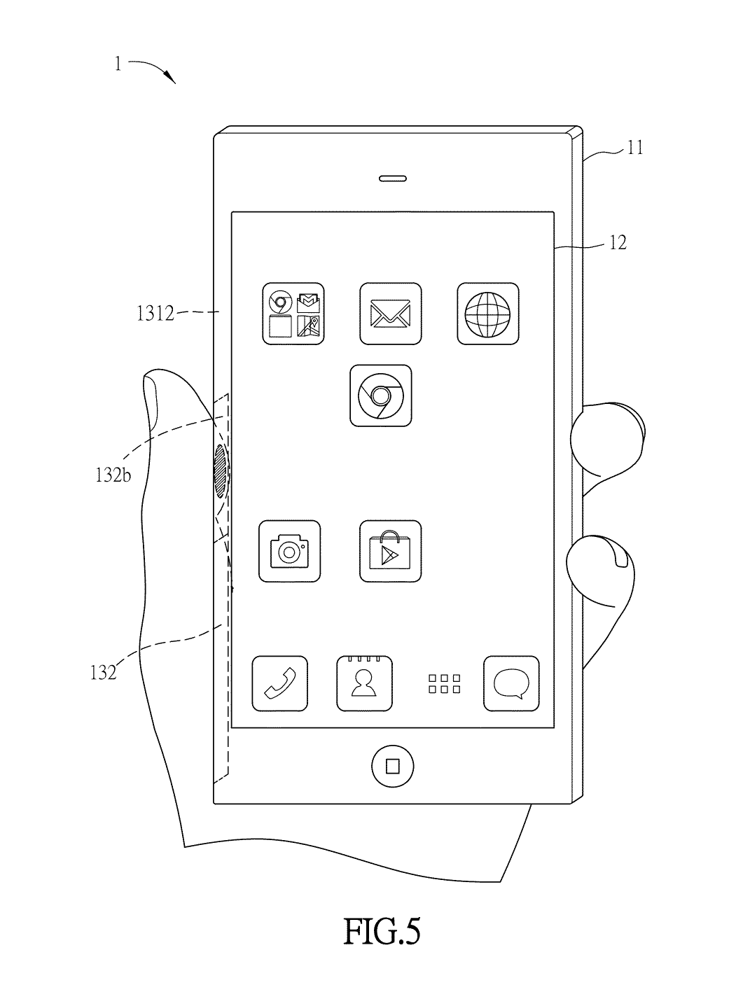

Referring to FIG. 3 to FIG. 5, FIG. 3 is a schematic diagram showing the activation area of the shadeless touch hand-held electronic device in FIG. 1, FIG. 4 is a schematic diagram showing the activation area of the shadeless touch hand-held electronic device according to another embodiment, and FIG. 5 is a schematic diagram showing the operation of the shadeless touch hand-held electronic device in FIG. 1.

The touch-sensing cover 13 provides the touch control manner for the user to input, and the user can interact with the GUI (graphical user interface) on the panel 11. Herein for example, the touch can be implemented by the user's finger or stylus contacting or nearly contacting the touch-sensing cover 13. Moreover, the interaction with the graphical user interface can be, for example, that the user contacts the touch-sensing cover 13 by the finger to perform the click, enlargement or movement.

The above-mentioned touch control can comprise, for example, an operation gesture or hand gesture, such as a single tap or multiple taps, a single slide or multiple slides (such as a rightward, leftward, upward or downward slide), sequential clicks by multiple fingers, or simultaneous slide by multiple fingers. In addition, the operation of the hand-held electronic device 1 in response to the hand gesture can be determined by factory settings and/or according to the user's habit.

The touch-sensing structure 132 in the embodiment includes a first sensing layer 1321a, a second sensing layer 1321b and a capacitance detection unit 1321c. Besides, the touch-sensing structure 132 can further include a power supply unit 1321d. For example, the first sensing layer 1321a is directly electrically connected with the capacitance detection unit 1321c, and the second sensing layer 1321b is directly electrically connected with the capacitance detection unit 1321d. Additionally, in some embodiments, the first sensing layer 1321a or the second sensing layer 1321b is capable of a wireless power transmission.

The touch-sensing structure 132 can also comprises a driving circuit and a sensing circuit (i.e. the so-called Tx and Rx by the skilled person in the art, not shown in the figure), and it can be a conductive layer (it may also be a transparent conductive layer, for example indium tin oxide (ITO), indium zinc oxide (IZO), fluorine-doped tin oxide (FTO), Al-doped ZnO, Ga-doped ZnO), metal mesh, metal nanowires, transparent conducting film, carbon nanotube or graphene, but it is not limited thereto.

If the touch-sensing structure 132 is made by metal mesh, the metal texture effect can be exhibited on the appearance when the touch-sensing structure 132 is disposed on the outer surface (not the display surface) of the cover 131. Accordingly for example, the cover of metal texture is implemented by disposing the touch-sensing structure 132 composed of the metal mesh on the outer surface (not the display surface) of the cover 131 made by non-metal material. Thus, the metal-made cover (requiring a more complicated process) is unnecessary to be used, so as to further saving the cost.

Because the touch-sensing structure 132 is electrically connected to the control unit 12, the user can operate the hand-held electronic device 1 on the touch-sensing cover 13. In other words, as to the hand-held electronic device 1 in the embodiment, the user performs the touch operation on the touch-sensing cover 13 by finger for example, and the panel 11 can display the corresponding operative instruction according to the user's operation gesture (or called the hand gesture). For example, when the user clicks on the touch-sensing cover 13 by his finger, the hand-held electronic device 1 will execute the target located corresponding to the position information. Therefore, directly controlling on the touch-sensing cover 13 and executing the structured electronic document or target displayed on the panel 11 is implemented.

The first sensing layer 1321a has a plurality of first sensing lines disposed along a first direction. The second sensing layer 1321b has a plurality of second sensing lines disposed along a second direction. The first sensing lines and the second sensing lines cross each other to form a plurality of detection points. The capacitance detection unit 1321c is electrically connected with the first sensing layer 1321a and the second sensing layer 1321b to detect the variation of the coupling capacitance between the first sensing lines and the second sensing lines to provide a first finger input signal. For example, when the user's finger touches or nearly contacts a certain detection point, the finger will change the charge coupling between the first sensing line and the second sensing line at the detection point so as to change the capacitance of the detection point. By the capacitance detection unit 1321c detecting the variation of the coupling capacitance between the first sensing line and the second sensing line, the touched position by the user's finger can be determined.

Besides, the capacitance detection unit 1321c can include one or multiple sensor IC, which is applied to detect the capacitance of each detection point and convert the analog capacitance signal into the digital capacitance signal and then transmit the digital capacitance signal to the control unit 12 electrically connected with the capacitance detection unit 1321c (FIG. 2, but the figure does not show the connection).

In other embodiments, at least a filter can be disposed between the first sensing lines and the capacitance detection unit 1321c and can be formed by an inverting amplifier circuit for example. The filter can eliminate the parasitic capacitance of the touch sensing structure 132, which comes from, for example, the capacitance effect between the first sensing lines, between the second sensing lines or between the sensing lines and the grounding level. In short, the filter can prevent the signal inputted to the capacitance detection unit 1321c from being affected by other capacitances except the capacitance at the detection point.

In other embodiment, for example, the touch-sensing structure may be a single-layer electrode structure. For example, the touch-sensing structure may include a plurality of sensing pads that are formed simultaneously, and the sensing pads may be in the form of a single layer structure. The sensing pads may be a transparent conductive layer or a metal mesh. The shape of the sensing pad includes, but not limited to, a triangle or a diamond shape, as long as they can help to achieve touch-sensing operations. Moreover, all sensing pads are not needed to have an identical shape.

The touch-sensing cover 13 includes a cover 131 and a touch-sensing structure 132. The cover 131 is disposed on the side of the hand-held electronic device 1 opposite the panel 11 (i.e. the opposite side to the display surface). Partial or total area of the touch-sensing structure 132 is disposed on the cover 131. In the embodiment, the cover 131 includes a cover body 1311 and a sidewall 1312 extending from at least a part of the edge of the cover body 1311. The touch-sensing structure 132 is electrically connected to the control unit 12, partial or total area of the touch-sensing structure 132 can be disposed on the cover body 1311. In this embodiment, in addition to being disposed on the cover body 1311, the touch-sensing structure 132 can extend to the sidewalls 1312 at the two sides of the cover 131. That is, the touch-sensing structure 132 extends from the cover body 1311 directly to the two side edges of the cover 131, so as to increase the operation area for the user. To more effectively utilize the width of the cover 131 for disposing the touch-sensing structure 132, the width of the touch-sensing structure 132 is less than that of the cover 131 (for example by 5%˜10%). Namely, the width of the touch-sensing structure 132 is about 90%˜95% of the width of the cover 131. In other embodiments, the touch-sensing structure 132 can be only disposed on the cover body 1311.

Besides, the touch-sensing structure 132 includes an activation area 132a to replace the physical button (such as a sound control button or power button). In detail in the embodiment, the activation area 132a replaces the conventional power button. Namely, the hand-held electronic device 1 has no physical power button. In the embodiment, after the activation area 132a being triggered, the hand-held electronic device 1 is activated to an operative state. In the embodiment, the activation area 132a is disposed on the lower part of the touch-sensing cover 13, for example near the place for holding by palm. Here, the center of the cover 131 or the center of the touch-sensing structure 132 can be used to distinguish the upper part and the lower part, but it still depends on actual situation when the user operates the hand-held electronic device 1. The portion upper than the center is regarded as the upper part, and the portion lower than the center is regarded as the lower part.

In addition, although “activation area” is called in the embodiment, it is not limited only to the operation of activated to an operative state. The activation area also can act as an instruction region to recognize various hand gestures for example initiating camera, adjusting sound volume or returning to non-operative state, and it is not limited thereto.

In other embodiments, the area of the touch-sensing structure 132 of the touch-sensing cover 13 can be smaller than the area of the panel 11. In other words, the area of the touch-sensing structure 132 and the area of the panel 11 have a ratio relationship to the area of the panel 11, and control unit 12 convert a touch point on the touch-sensing cover 132 into a display position of the panel 11 according to the ratio relationship.

When the user performs the touch operation on the touch-sensing cover 13 by finger for example, the panel 11 can display the corresponding operative instruction according to the user's operation gesture (or called the hand gesture), the control unit 12 will convert the input position of the touch-sensing structure 132 into the display position of the panel 11, and the panel 11 will display a visible sign on the display position so that the user can interact with the graphical user interface displayed on the panel 11.

Besides, a wiring connecting to the touch-sensing structure 132 is gathered to a single side for wiring outlet, and then electrically connected with a circuit board, so as to enhance the flexibility of the circuit design.

Here for example, “the hand-held electronic device 1 is activated to an operative state” means that the hand-held electronic device 1 is activated to the operative state from a sleep state, a standby state, a hibernate state, a hybrid sleep state or a shutdown state. Here for example, the sleep state means a state only under memory power. The hibernate state means a state that writes the data stored in the ram into the hard disk and stops operating each component. In other words, after writing the data into the hard disk, the hibernate state stop power supply to each component.

In the embodiment, the activation area 132a may be located at the cover body 1311 like FIG. 3, or alternatively the activation areas 132b, 132c are located at the sidewalls 1312 like FIG. 4. In the embodiment, the allocated position of the activation area 132a is fixed, and the touch-sensing structure 132 at this location can be only used to turn on/off the power but not to directly control or execute the panel 11. But in another embodiment, the position of the activation area can be adjusted by the user. When the touch-sensing structure 132 controls and executes the process on the panel 11, the activation area 132a acts as an ordinary touch-sensing structure 132. When the hand-held electronic device 1 is in the sleep state, the standby state, the hibernate state, the hybrid sleep state or the shutdown state, the activation area 132a acts for switching the states. For example, when the hand-held electronic device 1 is in the sleep state, partial of the touch-sensing structure 132 forms the activation area 132b. The activation area 132b is not an additional independent element from the touch-sensing structure 132.

The touch-sensing structure comprises metal mesh, metal nanowires, transparent conducting film, carbon nanotube or graphene. It avoids the metal interference fringe which lowers the readability of the display panel, and it also improves the signal of the sensing circuit and reduces interference.

The following description explains a possible method of initiative determination for the activation area 132a, but it is not limited thereto. When the user operates the hand-held electronic device 1, the user's holding habit can be predefined. The activation area 132a is determined whether to be triggered according to the trigger event detected by the activation area 132a, and then the hand-held electronic device 1 is activated to the operative state.

In detail, a trigger quantity, a trigger quantity distribution, a trigger morphology (which can refer to trigger appearance), a trigger time, a trigger location (which can refer to trigger position) or a trigger frequency of the detection points of the activation area 132a is computed. The control unit 12 can analyze the trigger quantity, the trigger quantity distribution, the trigger morphology, the trigger time, the trigger location or the trigger frequency of the detection points which is triggered by the user on the operation setting interface, and define it as the initiative determination condition and store it in the memory unit 14. In other words, the user's holding position or habit and so on during operating the hand-held electronic device 1 can be defined as the initiative determination condition.

When the user holds hand-held electronic device 1, the control unit 12 can analyze the position of the detection point triggered at the holding location, and define the region where the number of the adjacent triggered detection point is larger than a predetermined value as a trigger zone. Moreover, the trigger frequency indicates the click frequency at some certain locations, and the trigger time indicates that the holding time exceeds a certain time as the initiative determination condition, and thus a valid input action is regarded if the trigger time is longer than a predefined time period. Alternatively, a predefined trigger frequency is defined as the initiative determination condition. The predefined trigger frequency is regarded as a password like Morse Code. If the trigger frequency conforms to the initiative determination condition, the later input action is permitted to execute.

After setting the configuration, the control unit 12 computes the trigger quantity, the trigger quantity distribution, the trigger morphology, the trigger time, the trigger location or the trigger frequency of the detection points of activation area 132a at intervals of a predefined time period. Thus, assuming that the user's hand contacts the activation area 132a, after the control unit 12 receiving the touch signal, it can compute the trigger quantity, the trigger quantity distribution, the trigger morphology, the trigger time, the trigger location or the trigger frequency of the triggered detection points and compare the trigger quantity, trigger quantity distribution, trigger morphology, trigger time, trigger location or trigger frequency with the initiative determination condition pre-stored in the hand-held electronic device 1.

If the trigger quantity, the trigger quantity distribution, the trigger morphology, the trigger time, the trigger location or the trigger frequency conforms to the initiative determination condition, the activation area 132a is permitted to be triggered and the hand-held electronic device 1 is activated to the operative state.

In other words, the trigger quantity, the trigger quantity distribution, the trigger morphology, the trigger time, the trigger location or the trigger frequency must satisfy the initiative determination condition first, and then the hand-held electronic device can be activated to an operative state and permitted to be used.

Therefore, when another user holds the hand-held electronic device 1 and would like to operate it, he will fail to operate the hand-held electronic device 1 because the trigger quantity, the trigger quantity distribution, the trigger morphology, the trigger time, the trigger location or the trigger frequency is distinct from the initiative determination condition which the original user has predefined. The hand-held electronic device 1 can't be activated to the operative state. Therefore, the security of the hand-held electronic device 1 is enhanced.

Moreover, in one embodiment where the hand-held electronic device 1 is used in the strong light environment such as the outdoor sunlight or indoor high-illuminance light, the user can operate the hand-held electronic device 1 by one hand while the touch-sensing cover 13 faces the light source of the strong light environment (the panel 11 faces the user) and the back of the panel 11 faces the light source of the strong light environment (against the light), so the touch-sensing cover 13 can block the light source. Thereby, the visibility can be enhanced and the user can continue the single-hand operation. Furthermore, the user can hold the device by one hand and also perform the input operation with the forefinger and/or the middle finger, so as to enhance the single-hand operation performance of the hand-held electronic device 1 under the strong light source (such as the sunlight). Besides, in comparison with the conventional art where just the thumb can be used in the single-hand operation, the operation on the touch-sensing cover 13 by the forefinger or middle finger can provide more flexibility and a new user experience about the single-hand holding and multi-finger touch operation at the same time.

In one embodiment, the hand-held electronic device 1 further includes a wireless communication unit. The wireless communication unit for example includes at least one of infrared module, bluetooth module, zigbee module, radiofrequency module or NFC (near field communication) module. Taking NFC module for example, the NFC module has a NFC chip and an antenna. The NFC chip is electrically connected to the control unit 12. The antenna can be disposed on the cover 131 or integrated with the touch-sensing structure 132, and it is not limited thereto. When the user want to communicate with another electronic device through NFC, he can take the hand-held electronic device 1 close to another electronic device with NFC function, and transmit data to another electronic device or receive data from another electronic device through the antenna and the NFC chip.

As mentioned above, as to the shadeless touch hand-held electronic device and touch-sensing cover, the user can perform the touch operation on the touch-sensing cover of the hand-held electronic device, so the user's finger will not shade the view or the object displayed on the panel, and the touch for opening the link of the high information density image will not erroneously execute. Besides, since operating the electronic device is performed on the touch-sensing cover, scratch of the panel can be reduced. Furthermore, because the user can perform the touch operation on the touch-sensing cover, the user can use multiple fingers such as the forefinger and middle finger to operate the electronic device while using the same hand holding the device. In comparison with the conventional art where the user just can use the thumb to perform the operation while using the same hand holding the device, the disclosure can provide more manual efficiency and convenience and can achieve a better user experience.

Furthermore, when the user uses the hand-held electronic device under the sun, he can hold the hand-held electronic device just by one hand and use the touch-sensing cover to block the sunlight or light source. Due to the panel information resulting from the touch-sensing cover which blocks the sunlight, the sunlight visibility of the panel is improved, and it can be implemented without advanced OLED or electric paper display panel technique.

Besides, the activation area which is located at the touch-sensing structure of the touch-sensing cover replaces the conventional physical button and this avoids the physical button from easily breaking Because the shadeless touch hand-held electronic device has no physical button, the design of the hand-held electronic device is more flexible and the appearance is more streamlined.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A shadeless touch hand-held electronic device, comprising:
a panel;
a memory unit;
a touch-sensing cover, having a cover and a touch-sensing structure, wherein the cover is disposed on the side of the hand-held electronic device opposite the panel, partial or total area of the touch-sensing structure is disposed on the cover, and the touch-sensing structure has an activation area; and
a control unit, electrically connected to the touch-sensing structure and the memory unit;
wherein after the activation area being triggered, the shadeless touch hand-held electronic device is activated to an operative state.

2. The shadeless touch hand-held electronic device of claim 1, wherein after the activation area being triggered, the shadeless touch hand-held electronic device is activated to the operative state from a sleep state, a standby state, a hibernate state, a hybrid sleep state or a shutdown state.

3. The shadeless touch hand-held electronic device of claim 1, wherein the activation area acts for being triggered.

4. The shadeless touch hand-held electronic device of claim 3, wherein the cover further comprises a cover body and at least one sidewall, the sidewall extends from at least a part of the edge of the cover body, and the activation area is disposed on the cover body or the sidewall.

5. The shadeless touch hand-held electronic device of claim 1, wherein when the shadeless touch hand-held electronic device is in a sleep state, a standby state, a hibernate state, a hybrid sleep state or a shutdown state, partial of the touch-sensing structure forms the activation area.

6. The shadeless touch hand-held electronic device of claim 1, wherein the touch-sensing structure comprises metal mesh, metal nanowires, transparent conducting film, carbon nanotube or graphene.

7. The shadeless touch hand-held electronic device of claim 1, wherein the touch-sensing structure comprises:
a first sensing layer, having a plurality of first sensing lines disposed along a first direction;
a second sensing layer, disposed opposite the first sensing layer and having a plurality of second sensing lines disposed along a second direction, wherein the first sensing lines and the second sensing lines cross each other to form a plurality of detection points; and
a capacitance detection unit, coupled with the touch-sensing structure to detect the variation of the coupling capacitance between the first sensing lines and the second sensing lines.

8. The shadeless touch hand-held electronic device of claim 1, wherein the hand-held electronic device is operated by one hand.

9. The shadeless touch hand-held electronic device of claim 8, wherein the shadeless touch hand-held electronic device has no physical power button.

10. The shadeless touch hand-held electronic device of claim 1, further comprising a circuit board, a battery or a memory card between the touch-sensing cover and the panel.

11. The shadeless touch hand-held electronic device of claim 1, wherein the activation area is disposed on the lower part of the touch-sensing cover.

12. The shadeless touch hand-held electronic device of claim 1, wherein the memory unit stores an initiative determination condition, and the control unit on the activation area executes following steps of:
computing a trigger event of the detection points;
comparing the trigger event with the initiative determination condition pre-stored in the hand-held electronic device; and
wherein the activation area is triggered if the trigger event conforms to the initiative determination condition.

13. The shadeless touch hand-held electronic device of claim 1, wherein the area of the touch-sensing structure and the area of the panel have a ratio relationship, and the control unit converts an input position of the touch-sensing structure into a display position of the panel

14. The shadeless touch hand-held electronic device of claim 1, further comprising a near field communication unit, wherein the near field communication unit has a near field communication chip and an antenna, the near field communication chip is electrically connected to the control unit, and the antenna is disposed on the cover or the touch-sensing structure.

15. The shadeless touch hand-held electronic device of claim 1, wherein the touch-sensing structure is capable of a wireless power transmission.

16. A touch-sensing cover, disposed on a shadeless touch hand-held electronic device having a control unit, comprising:
a cover; and
a touch-sensing structure, electrically connected to the control unit, wherein partial or total area of the touch-sensing structure is disposed on the cover, and the touch-sensing structure has an activation area, wherein after the activation area being triggered, the shadeless touch hand-held electronic device is activated to an operative state.

17. The touch-sensing cover of claim 16, wherein after the activation area being triggered, the shadeless touch hand-held electronic device is activated to the operative state from a sleep state, a standby state, a hibernate state, a hybrid sleep state or a shutdown state.

18. The touch-sensing cover of claim 16, wherein the touch-sensing structure comprises:
a first sensing layer, having a plurality of first sensing lines disposed along a first direction;
a second sensing layer, disposed opposite the first sensing layer and having a plurality of second sensing lines disposed along a second direction, wherein the first sensing lines and the second sensing lines cross each other to form a plurality of detection points; and
a capacitance detection unit, coupled with the touch-sensing structure to detect the variation of the coupling capacitance between the first sensing lines and the second sensing lines.

19. The touch-sensing cover of claim 16, wherein the activation area is disposed on the lower part of the touch-sensing cover.

20. The touch-sensing cover of claim 16, wherein the control unit on the activation area executes following steps of:
computing a trigger event of the detection points;
comparing the trigger event with the initiative determination condition pre-stored in the hand-held electronic device by the control unit; and
wherein the activation area is triggered if the trigger event conforms to the initiative determination condition.
